(19) United States
(12) Patent Application Publication
(10) Pub. No.: US 2026/0145100 A1
(43) Pub. Date: May 28, 2026

(54) APPLICATION OF MICROCAPSULES IN ANTIFOAMING FORMULATIONS BASED ON SILICONES AND THEIR DERIVATIVES, PROCESS FOR PREPARING MICROCAPSULES, AND METHOD FOR REDUCING FOAM IN OIL

(71) Applicants: PETRÓLEO BRASILEIRO S.A. - PETROBRAS, Rio de Janeiro (BR); UNIVERSIDADE FEDERAL DO RIO DE JANEIRO - UFRJ, Rio de Janeiro (BR)

(72) Inventors: Osvaldo Karnitz Junior, Rio de Janeiro (BR); Mariana Teixeira Mendes, Rio de Janeiro (BR); Claudia Regina Elias Mansur, Rio de Janeiro (BR); Andressa Oliveira Dos Santos, Rio de Janeiro (BR); Rafael Farias Perez, Rio de Janeiro (BR); Robson Pereira Alves, Rio de Janeiro (BR); Luiz Felipe Silva Do Carmo, Rio de Janeiro (BR)

(21) Appl. No.: 19/389,530

(22) Filed: Nov. 14, 2025

(30) Foreign Application Priority Data
Nov. 22, 2024 (BR) 1020240242653

(51) Int. Cl. B01D 19/04; C09K 23/54

(52) U.S. Cl. CPC B01D 19/0409; C09K 23/54

(57) ABSTRACT

The present invention relates to the application of microcapsules containing silicones and their derivatives in new antifoaming formulations and their application method for the chemical treatment of oil foam during primary processing and their application method. Said formulations, in the suspension or emulsion form, further comprise additional components in the form of surfactants, organic solvents, and others, enhancing the antifoaming action of the formulations in oil.

### RELATED APPLICATIONS

This application claims the benefit of priority to Brazilian Patent Application No. 1020240242653, filed Nov. 22, 2024, the entire contents of which are incorporated herein by reference.

### FIELD OF THE INVENTION

The present invention relates to the field of chemical treatment of oil and its emulsions in primary oil processing. More specifically, the present invention discloses the application of formulations containing microcapsules, with silicones and their derivatives, as antifoams and defoamers, as well as their method of application for the chemical treatment of foam in oil.

### BACKGROUNDS OF THE INVENTION

Foam formation in oil products is a persistent problem found at various steps of exploration, production, and refining. Foam not only reduces the efficiency of the industrial processes but also poses process safety risks and compromises the product quality. Traditional antifoaming active ingredients have limitations in terms of miscibility, composition, shelf life, and product efficacy.

Coupled with these characteristics of oil production, the exploration and production of offshore reservoirs located at increasing distances from the coast, located at great water depths, is driving a current trend toward reducing the size and weight of primary processing plants. However, this trend indicates the need for a significant increase in the amount of antifoaming agent to enable the foam treatment and the gas-liquid separation.

The silicones and their derivatives are the main active ingredients in all oil antifoaming products. These active ingredients have been used in oil production since 1970, and since 1980 they have been established as the only technically and economically viable raw material used for oil treatment, a position they have held to this day (Pape, P. G. Silicones: Unique Chemical for Petroleum Processing. Journal of Petroleum Technology, vol. 35, June 1983; Hera, J., & Gingrich, R. Overcoming the Unique Production Chemistry Challenges of Subsea Separation, and Subsea Boosting for the Parque das Conchas (BC-10) Development. Offshore Technology Conference, May 2010; Perez, Santos, Macedo, Mendes, Ramalho, Karnitz, and Mansur. Surface activity of PDMS silicone oil applied as petroleum antifoamer. Journal of Applied Polymer Science, November 2023).

However, the silicon present in the antifoaming composition causes oil contamination. Silicon-contaminating oil can deposit on catalysts in refining and petrochemical units, deactivating the same, which can result in the reduction in the operational campaign time of these units. This occurs due to the decreased efficiency of the catalysts due to inactivation by the silicon oxide coating, thus impairing the overall operational performance. (Kapusta, Sergio D., van den Berg, Frans, Daane, Rinus, and Morris C. Place, “The Impact of Oil Field Chemicals on Refinery Corrosion Problems,” Corrosion, 2003, San Diego, California).

Recent researches, developments, and innovations describe the use of silicon-free antifoaming agents for oil treatment. However, the use of these active ingredients for separating gas from liquid is only possible in doses dozens of times higher (500 ppm-1,000 ppm) than those of silicone-based products (5 ppm-100 ppm), highlighting the problem of the need for large injection systems, large volumes to be acquired, transported and moved, in addition to the excessive cost of the process (Carbajal, Formulations of copolymers based on alkyl acrylates used as defoamers of heavy and super-heavy crude oils, Patent US010221349B2, March 2019; Hatchman, Foam control formulations, Patent US 2015 0080273A1, March 2015; Cevada, Formulations of homopolymers based on alkylacrylates used as antifoaming agents in heavy and super-heavy crude oils, June 2015).

Scientific publications also describe studies on improving the antifoaming efficacy of silicones, focusing on modifying the molecule with diverse organic structures, heteroatoms, and combinations of different silicones. Among the silicone derivatives developed and used as antifoaming agents are fluorosilicone and polyether silicone. However, there is little investment in improving the formulation methodology, which could reduce product dosage and silicon contamination of oil (Fraga, A. K. et al. “Development and evaluation of oil-in-water nanoemulsions based on polyether silicone as demulsifier and antifoam agents for petroleum,” Journal of Applied Polymer Science, Vol. 131, October 2014; Kobayashi, Fluorosilicone polymers and methods for preparation, Patent EP0577047A1, June 1993; Gallagher, Method and composition for suppressing oil-based foams, U.S. Pat. No. 5,853,617, May 1997).

The combined use of two antifoaming products, one with silicone as the active ingredient and the other with fluorosilicone as the active ingredient, to enhance gas-liquid separation has already been patented (C. T. Gallagher, P. J. Breen, B. Price. Applicant: Baker Performance Chemicals. U.S. Pat. No. 5,853,617A. Filing: May 14, 1997. Grant: Dec. 29, 1998). It should be highlighted that, although it is already known that the combined use (co-injection) of two products, one based on fluorosilicone and the other based on silicone, enhances the antifoaming action in the oil, it is also known that this demand has the disadvantage of duplicating the antifoaming agent injection system in industrial plants, since both active ingredients are insoluble in each other, even in co-solvents, makes it difficult to formulate such products and to prepare homogeneous formulations for uniform application in the separator vessel. Currently, the antifoaming products used in the chemical treatment of oil foam are administered through systems that inject the antifoaming additive at certain dosage points in the primary oil processing industrial plant, in the form of formulations containing only pure silicone, either dissolved or emulsified. However, none of these known formulations presents in their compositions the combination of antifoaming agents such as silicones and/or their derivatives as active ingredients, using only one injection system in the industrial plant, instead of two, as in the present invention.

Some documents describe antifoaming formulations, but none of them present the features of the present invention.

In this regard, U.S. Pat. No. 4,039,469A discloses a method for preparing an emulsified aqueous organosilicon-based antifoaming composition. However, the document does not use a mixture of silicone and its derivatives to enhance the antifoaming action.

U.S. Pat. No. 10,870,732B2 presents an antifoaming formulation comprising polysiloxane. Like the aforementioned document, this document does not combine different silicones and their derivatives to enhance the antifoaming action.

Microencapsulation has been studied and used in various industrial fields, enabling the development of formulas with different actions, such as controlled release of active ingredients, reduced toxicity, and reduced environmental contamination. The microcapsules are particles consisting of an inner core containing the active agent coated with a polymer layer of varying thickness.

Thus, the present invention provides antifoaming compositions comprising silicone and/or its derivatives in a single formulation by means of the use of microcapsules, utilizing only one injection system in the industrial plant.

In these formulation, the integration of microcapsules as carriers for antifoaming agents present an innovative approach to overcoming the challenges previously described, offering increased component possibilities in the formulation, generating increased performance.

### SUMMARY OF THE INVENTION

In one embodiment, the present invention provides an antifoaming formulation for oil, in the form of a suspension or emulsion, which comprises 0.1 to 10% by mass of silicone, polyether silicone, or fluorosilicones, 1 to 20% wt of encapsulating material, and 0 to 15% wt of organic solvents, and at least two surfactants present in amounts of 2 to 22% by mass.

In a preferred embodiment, said silicones are preferably present at 0.1% by mass and are selected from the group comprising fluorosilicone, preferably trifluoropropyl (TFP) methylsiloxane, polyether silicone, or polydimethylsiloxane, or a mixture of these active ingredients.

In one embodiment, the fluorosilicone and the silicone are present and inserted into microcapsules.

In another embodiment, the fluorosilicone is inserted into the microcapsule and the silicone is dispersed in the emulsion.

In another embodiment, the silicone is inserted into the microcapsule and the fluorosilicone is dispersed in the emulsion.

In one embodiment, the silicone and/or its derivatives are preferably present at 1% by mass.

In one embodiment, the microcapsules are prepared from the group comprising cellulose derivatives, such as methyl cellulose, ethyl cellulose, hydroxymethyl cellulose, carboxymethyl cellulose, hydroxypropyl cellulose, cellulose acetate; polyacetates, such as polyvinyl acetate and polyethyl acetate; polymethacrylates, such as polyalkyl methacrylate, preferably butyl methacrylate, and other branches such as isobutyl, 2-ethylhexyl, 3,5,5-trimethylhexyl, isodecyl, lauryl, not limiting; polycaprolactone; polystyrene; polyacrylamide.

In one embodiment, the organic solvents are preferably present at 0 to 15% by mass and are selected from the group comprising butanone, ethyl acetate, kerosene, Solbrax (Petrobras), heptane, tributyl phosphate, and cardanol.

In one embodiment, the surfactants are preferably present at 10% wt and are selected from the group comprising Span 80, Tween 80, dodecylbenzenesulfonic acid (DBSA); sodium dodecylbenzene sulfonate (SDBS); ethoxylated nonylphenol with an ethoxy chain of 2-20 units, more specifically 9.5 units (NP95); ethoxylated alcohols, more specifically, Alkonat L70 and L90; polyethylene glycol, polypropylene glycol, or a copolymer composed of both, more specifically pluronic 31R1 and pluronic 10R5; sodium lauryl sulfate; polyvinyl alcohol (PVA); and polyvinyl methyl ether.

In a preferred embodiment, the silicone-based active ingredient is emulsified in the liquid dispersant mixture of the formulation and the fluorosilicone is emulsified inside the microcapsules present in the formulation.

In another embodiment, the invention provides a process for preparing microcapsules of silicone and/or their derivatives, which comprises:
(a) preparing an oily solution of a solvent, a encapsulating material the microcapsule shell, and at least one silicone-based active ingredient and/or its derivatives;
(b) dispersing the solution obtained in (a);
(c) removing the solvent; and
(d) washing the solids.

In a preferred embodiment, the solvent of the process described above is selected from the group comprising butanone, ethyl acetate, ethanol, kerosene, Solbrax (Petrobras), chloroform, heptane, tributyl phosphate and cardanol, the shell-forming substance is selected from the group comprising cellulose derivatives, such as methyl cellulose, ethyl cellulose, hydroxymethyl cellulose, carboxymethyl cellulose, hydroxypropyl cellulose, cellulose acetate; polyacetates, such as polyvinyl acetate and polyethyl acetate; polymethacrylates, such as polyalkyl methacrylate, preferably butyl methacrylate, and other branches such as isobutyl, 2-ethylhexyl, 3,5,5-trimethylhexyl, isodecyl, lauryl, not limiting; polycaprolactone; polystyrene; polyacrylamide; and the active ingredient is selected from the group comprising fluorosilicone, preferably trifluoropropyl (TFP) methylsiloxane, polyether silicone, or polydimethylsiloxane, or a mixture of these active ingredients.

In an even more preferred embodiment, the solvent is ethyl acetate (0 to 100% v/v), the microcapsule shell-forming substance is ethyl cellulose (0 to 20% w/v), and the active ingredient is fluorosilicone (0 to 20% w/v).

In another embodiment, the invention provides a method for reducing foam in oil, which comprises applying the aforementioned formulation to an injection system in an industrial plant during the primary oil processing.

### BRIEF DESCRIPTION OF THE INVENTION

The present invention relates to the field of chemical treatment of oil and its emulsions during the primary processing. More specifically, the present invention discloses new antifoaming formulations comprising polymeric microcapsules containing silicones and other derivatives, and their method of application for the chemical treatment of foam in oil, allowing the combination of antifoaming substances that are not feasible to formulate together.

The present invention describes antifoaming and defoaming formulations for oil, which can be presented in the form of an aqueous suspension or emulsion. In the suspension form, the formulations comprise 0.1 to 20% by mass of silicones, 1 to 20% wt of encapsulating material, and up to 10% wt of surfactants. In the emulsion form, the formulations further comprise up to 20% wt of organic solvents. The invention also describes a process for preparing the microcapsule and a method for reducing foam in oil.

### DETAILED DESCRIPTION OF THE INVENTION

The present invention relates to the field of chemical treatment of oil and its emulsions by describing new antifoaming and defoaming formulations comprising microcapsules filled with silicones and/or their derivatives and their application method for the chemical treatment of oil foam.

The aforementioned formulations are useful for use in primary oil processing and contain antifoaming active ingredients, silicones, and their derivatives, by means of the polymeric encapsulation and dispersion in water, in the form of aqueous dispersions and emulsions. The formulations, as described below, allow dosing by an injection system upstream of the processing plant, in the production arrival region, at the industrial plant, reducing the need for application at multiple points.

The present invention solves the problems of the art by providing formulations containing one or more antifoaming active ingredients by means of the use of microcapsules, with the active ingredients being entirely inside the microcapsules or a portion emulsified in water and the other emulsified inside the microcapsules.

In this way, the present formulations provide:
(1) enhanced antifoaming action through the combined use of the active ingredients simultaneously in the same composition;
(2) use of only one injection system in the industrial plant, instead of two;
(3) the use of Span 80 and Tween surfactants in the formulations further increases the antifoaming efficiency of the formulation, when compared to the dosage of both active ingredients separately or the dosage of both active ingredients in solvent; and
(4) the possibility of making more specific formulations for each type of oil, by varying the amounts of different active ingredients.

Through the microencapsulation technique, it was possible to store different types and structures of silicone and its derivatives, previously immiscible, and suspend the same in an aqueous medium, using different polymers to compose the capsule.

This technique aims at storing species present in the core, some of which can make the formulations insoluble or unstable when combined, providing controlled permeability under the desired conditions, allowing the release of the substances only after the injection into the oil stream. This makes dosing feasible at an initial point in the industrial plant, with the release of the silicones and their derivatives only in the presence of oil, within the processing plant, enabling increased efficiency of antifoaming products and reduced silicon contamination of the oil.

The formulations can be prepared by mixing microcapsules containing any type of silicones and their derivatives, or by dispersing microcapsules containing any type of silicones derivatives in an emulsion of any type of silicone, or by dispersing microcapsules containing any type of silicone derivatives in an emulsion of any type of silicone and/or silicone derivative.

Specifically, the active ingredients can be entirely inside the microcapsules, or a portion thereof can be emulsified in water and the other emulsified inside the microcapsules.

Accordingly, the innovation of the present invention is distinguished primarily by: (i) Encapsulation of different antifoaming agents using methods such as interfacial polymerization, coacervation, or solvent evaporation; (ii) Optimized size and morphology to facilitate the uniform dispersion within oil products and allow the efficient release of the encapsulated agents; (iii) Controlled release mechanism, triggered by specific temperature and agitation conditions; and (iv) water-based formulations, Tween, and Span, in specific proportions, which allow for efficient carrying of the microcapsules.

In the context of the present invention, the terms “composition” and “formulation” are used interchangeably.

In the context of the present invention, the term “active ingredients” refers to silicone compounds and their derivatives.

In the context of the present invention, the term “solution” can be understood as a homogeneous system of two or more substances. In the context of the present invention, the term “suspension” describes a heterogeneous mixture of substances.

In the context of the present invention, the term “emulsion” can be understood as a dispersion in which the dispersed phase is an insoluble and immiscible liquid distributed in a carrier, or a dispersing phase.

In the context of the present invention, the term “microcapsule” can be understood as a small particle coated with a thin film comprising an active ingredient or a desired ingredient inside the same, with diameters typically ranging from 1 to 1000 μm. The coating material controls the release of the core material, providing protection and enabling the controlled release in various applications. The material contained in the microcapsule is called the core, internal phase, or fill, while the coating film is called the shell, coating, or membrane. Some materials such as lipids and polymers can be used as a mixture to form the coating film and retain the material of interest inside the same.

In one embodiment, the silicone compound of the present invention is a polymer of formula [R₂SiO]ₙ, in which R is an organic group such as alkyl or phenyl and n is an integer. In particular, the silicone and its derivatives are selected from the group consisting of fluorosilicone, such as trifluoropropyl (TFP) methylsiloxane or another fluorosilicone known in the art, polyether silicone, and polysiloxanes such as polydimethylsiloxane and cyclic siloxanes, or a mixture of these active ingredients.

In one embodiment, said formulations comprise emulsions of 0.1% to 50% by mass, preferably 1% by mass, of microcapsules preferably filled with 5% to 30% w/w of any type of polydimethylsiloxane, polyether silicone, and/or fluorosilicones, preferably 10% w/w, preferably trifluoropropyl methylsiloxane, without limitation; 0% to 15% by mass of organic solvents, preferably 5%; they further comprise at least two surfactants present in amounts of 2% to 22%, preferably 10% by mass.

In one embodiment, the formulations may have the active ingredients entirely inside the microcapsules or a portion emulsified in water and the other emulsified inside the microcapsules.

In a preferred embodiment, the formulation may contain the polydimethylsiloxane and/or polyether silicone emulsified in the medium, while the fluorosilicone may be inserted into microcapsules or the polydimethylsiloxane, polyether silicone, and/or fluorosilicone may be part of the formulation inside the microcapsules.

In one embodiment, the compounds selected for the synthesis of the microcapsules applied in said formulations are selected from groups of polymers such as cellulose derivatives, such as methyl cellulose, ethyl cellulose, hydroxymethyl cellulose, carboxymethyl cellulose, hydroxypropyl cellulose, cellulose acetate, among other cellulose derivatives known in the art; polyacetates, such as polyvinyl acetate, polyethyl acetate, among other polyacetates known in the art; polymethacrylates, such as polyalkyl methacrylate, butyl methacrylate, polyvinyl acrylate, and other branches such as isobutyl, 2-ethylhexyl, 3,5,5-trimethylhexyl, isodecyl, lauryl, among other polymethacrylate derivatives known in the art; polycaprolactone; polystyrene; polyacrylamide.

In a preferred embodiment, the compound selected for the synthesis of the microcapsules applied in said formulations is ethyl cellulose or butyl methacrylate.

In one embodiment, the organic solvents of the present invention are selected from the group comprising butanone, ethyl acetate, kerosene, Solbrax (Petrobras), heptane, tributyl phosphate (TBF), cardanol, among other solvents known in the art.

In a preferred embodiment, the solvent is tributyl phosphate.

In one embodiment, the surfactants of the formulations of the present invention are selected from Span 80, Tween 80, dodecylbenzenesulfonic acid (DBSA); sodium dodecylbenzene sulfonate (SDBS); ethoxylated nonylphenol with an ethoxy chain of 2-20 units, more specifically 9.5 units (NP95); ethoxylated alcohols, more specifically, Alkonat L70 and L90; polyethylene glycol, polypropylene glycol, or a copolymer composed of both, more specifically pluronic 31R1 and pluronic 10R5; sodium lauryl sulfate; polyvinyl alcohol (PVA) and polyvinyl methyl ether, among other surfactants known in the art.

In a preferred embodiment, the surfactant is Span 80 and Tween 80.

### EXAMPLES OF EMBODIMENT

Physical process simulations were performed in the laboratory to evaluate the efficiency of the formulations of the present invention.

The present invention is further illustrated with reference to the following examples that describe both the preparation of emulsions and their efficacy as antifoaming additives.

### Example 1

Microcapsules were obtained using the solvent evaporation method (adapted from SAEZ, V.; FREITAS, J. M.; HERNANDÉZ, J. R.; MANSUR, C. R. E. Validation of UV spectrophotometric method for quantifying ketoconazole encapsulated in ethyl cellulose microspheres. Macromolecular Symposia, 2018, 380, 1800066). Initially, an oily solution of 40 mL of ethyl acetate containing 5% w/v of ethyl cellulose and 0.5% w/v of fluorosilicone was prepared. The solution was then dispersed using an Ultra Turrax T50 homogenizer in 160 mL of an aqueous solution containing 0.1% w/v of polyvinyl alcohol (PVA). The suspension formed was evaporated at reduced pressure (5.3 bar-530 kPa) in a rotary evaporator for 2 h at 40° C. to remove the ethyl acetate. The solids formed were then washed three times with distilled water and dried by lyophilization.

### Example 2

The microcapsules synthesized in Example 1 were suspended in distilled water at a ratio of 0.1% (w/v), with the addition of 2% (w/v) of Tween 80 and 8% (w/v) of Span 80, using ultrasound.

### Example 3

The microcapsules synthesized in Example 1 were dispersed in distilled water at a ratio of 0.1% (w/v), with the addition of 2% (w/v) of Tween 80, 8% (w/v) of Span 80, and 5% of tributylphosphate, using ultrasound.

### Example 4

150 mL of properly homogenized 30° API oil were transferred to a compression cell, without the additive formulation described in Example 1. The cell was closed, vigorously stirred for approximately 2 minutes, and placed in a rolling oven for 120 minutes at 45° C. Finally, the tank was pressurized with compressed air at 200 psi (1.4 MPa) for 3 minutes and returned to the rolling oven for another 60 minutes. The spiral was then connected to the cell valve and positioned with the outlet valve facing down in an apparatus. The oil was then decompressed into a 100 mL measuring cylinder kept at the same temperature as the oven until a volume of approximately 80 mL was reached. The volume of foam formed was measured every 15 seconds until a constant value was reached. All tests were performed at least in duplicates. Subsequently, tests were performed with the emulsion described in Example 1, dosing 20 ppm at the oil before closing the cell.

To calculate the percentage of foam formed, equation 1 below was used:

$$FOAM ( \% v / v ) = ( V - {V}_{F} ) / {V}_{F} \times 100 \qquad ( 1 )$$

Where V is the volume reached by the foam on the scale at each time interval, and V_{F} is the final volume reached by the liquid after breaking all the foam formed. The Foam Control Index (FCI) considers the sum of the percentages of foam formed over time until the stabilization, comparing the test of the oil with the additive to the oil without the additive, according to equation (2) below:

$$FCI = \sum \% oil foam - \sum \% surfactant oil ) / \sum \% oil foam \qquad ( 2 )$$

Where Σ (% oil foam) refers to the sum of the percentages of foam formed in the oil sample without additives over time; Σ (% surfactant foam) refers to the sum of the oil sample dosed with the surfactants to be evaluated over time. The FCI value ranges from 0 to 1, with interest being the value closest to 1.

### Example 5

Example 4 was reproduced with 20° API oil and a test temperature of 65° C.

### Example 6

Example 5 was reproduced with a dosage of the emulsions from Example 3 of 500 ppm.

### Examples 7-17

Examples 2 and 3 were repeated with a change in the compound used in the shell of the fluorosilicone-containing microspheres, as listed in Table 1. As expected from the amount of water in the composition (>80%), the viscosities of all suspensions were close to 1 cP.

TABLE 1
Antifoaming formulations produced from aqueous suspension or aqueous
emulsion of fluorosilicone (FS)-containing microcapsules.

| | | FS | Organic | | |
|---|---|---|---|---|---|
| Example | Capsule Material | (% w/v) | Solvent | Dosage | |
| 7 | Ethyl cellulose | 0.09 | — | 20 | ppm |
| 8 | Poly(caprolactone) | 0.08 | — | 20 | ppm |
| 9 | Polystyrene | 0.11 | — | 20 | ppm |
| 10 | Poly(butyl methacrylate) | 0.08 | — | 20 | ppm |
| 11 | Poly(vinyl acrylate) | 0.11 | — | 20 | ppm |
| 12 | Ethyl cellulose | 0.09 | 5% TBF | 20 | ppm |
| 13 | Poly(caprolactone) | 0.08 | 5% TBF | 20 | ppm |
| 14 | Poly(butyl methacrylate) | 0.08 | 5% TBF | 20 | ppm |
| 15 | Ethyl cellulose | 0.09 | 5% TBF | 500 | ppm |
| 16 | Poly(caprolactone) | 0.08 | 5% TBF | 500 | ppm |
| 17 | Poly(Butyl Methacrylate) | 0.08 | 5% TBF | 500 | ppm |

Table 2 presents the results of the initial percentage of foam formed (% foam) and the foam control index (FCI) for the examples described according to Example 4.

TABLE 2
Initial percentage of foam formed and foam control index
of the samples dosed at 20 ppm applied in Example 4.

| | | | Initial | |
|---|---|---|---|---|
| | | T | Foam | FCI |
| Example | Oil 30° API | (° C.) | (%) | (%) |
| 4 | No additive | 45 | 237 | 0.00 |
| 7 | Ethyl cellulose | 45 | 130 | 0.64 |
| 8 | Poly(caprolactone) | 45 | 215 | 0.06 |
| 9 | Polystyrene | 45 | 190 | 0.04 |
| 10 | Poly(Butyl Methacrylate) | 45 | 203 | 0.12 |
| 11 | Polyvinyl acrylate | 45 | 240 | 0.01 |

From the results presented in the Examples, it can be observed that it was possible to reduce the initial foam formation value in 30° API oil from 237% to 130% with the suspension of ethyl cellulose microcapsules (Example 7). It is noteworthy that the content of fluorosilicones contained in the microsphere is in the range of 0.1% w/v of the formulation, severely reducing the silicon concentration present in the formulation composition. The FCI of this sample was 0.64, demonstrating the increase in breakage kinetics with the application of the formulation. The polystyrene sample had an initial foam formation value of 190; however, the FCI value shows that the breakage kinetics were not significantly reduced.

Table 3 presents the results of the initial percentage of foam formed (% foam) and the foam control index (FCI) for the examples described in examples 5 and 6.

TABLE 3
Initial percentage of foam formed and foam control
index of the samples applied in examples 5,
dosed at 20 ppm, and 6, dosed at 500 ppm.

| | | | Initial | |
|---|---|---|---|---|
| | | T | Foam | FCI |
| Example | Oil 20° API | (° C.) | (%) | (%) |
| 5 | No additive | 65 | 88 | 0.00 |
| 12 | Ethyl cellulose 20 ppm | 65 | 77 | 0.13 |
| 13 | Poly(caprolactone) 20 ppm | 65 | 82 | 0.00 |
| 14 | Poly(butyl methacrylate) 20 ppm | 65 | 82 | 0.07 |
| 15 | Ethyl cellulose 500 ppm | 65 | 54 | 0.54 |
| 16 | Poly(caprolactone) 500 ppm | 65 | 66 | 0.43 |
| 17 | Poly(butyl methacrylate) 500 ppm | 65 | 60 | 0.26 |

In the group of emulsions presented in Table 3, the ethyl cellulose formulation (Example 12) again stands out, with a decrease from 88% of the initial foam formed in 20° API oil was reduced to 77%, with an FCI of 0.13. At a higher dosage, the same sample showed a reduction to 54% of the initial foam, with an FCI of 0.54, a significant increase in foam-breaking kinetics.

The present invention has the following advantages:
Economic/Productivity: Reduced possibility of oil depreciation or rejection, since the formulations described here provide a significant reduction in the silicon dosage in oil. Formulations with lower active ingredient contents and/or using water as a carrier tend to have lower production costs than the commercial product (higher active ingredient content and using mineral oil as a solvent);
Reliability: Reducing the silicon content increases the campaign time in refining catalytic units, whose costs are currently being reduced by deactivating the silicon catalyst; and
Environmental: reduced toxicity of the additive for formulations that use water as a dispersant, which is less toxic (when considering organic solvents) to humans and the environment.

Those skilled in the art will value the knowledge presented herein and will be able to reproduce the invention in the presented embodiments and in other variations encompassed by the scope of the appended claims.

1. An antifoaming formulation for oil, wherein it is in the form of a suspension or emulsion, in which the formulation comprises 0.1 to 10% by mass of silicone, polyether silicone, or fluorosilicones, 1 to 20% of encapsulating material, and 0 to 15% of organic solvents, and at least two surfactants present in amounts of 2 to 22% by mass.

2. The formulation according to claim 1, wherein the silicones are preferably present at 0.1% by mass, and are selected from the group comprising fluorosilicone, preferably trifluoropropyl (TFP) methylsiloxane, polyether silicone, polydimethylsiloxane, cyclic siloxanes or a mixture of the active ingredients.

3. The formulation according to claim 1, the fluorosilicone and silicone present are inserted into microcapsules, the fluorosilicone is inserted into a microcapsule and the silicone dispersed in the emulsion, or the silicone is inserted into the microcapsule and the fluorosilicone is dispersed in the emulsion, preferably at 1% by mass, wherein the microcapsules are selected from the group comprising cellulose derivatives, such as methyl cellulose, ethyl cellulose, hydroxymethyl cellulose, carboxymethyl cellulose, hydroxypropyl cellulose, cellulose acetate; polyacetates, such as polyvinyl acetate and polyethyl acetate; polymethacrylates, such as polyalkyl methacrylate, preferably butyl methacrylate, and other branched alkyls such as isobutyl, 2-ethylhexyl, 3,5,5-trimethylhexyl, isodecyl, lauryl, not limiting; polycaprolactone; polystyrene; polyacrylamide.

4. The formulation according to claim 1, wherein the organic solvents are preferably present at 0 to 15% by mass and are selected from the group comprising butanone, ethyl acetate, kerosene, Solbrax (Petrobras), heptane, tributyl phosphate, and cardanol.

5. The formulation according to claim 1, wherein the surfactants are preferably present at 10% and are selected from the group comprising Span 80, Tween 80, dodecylbenzenesulfonic acid (DBSA); sodium dodecylbenzene sulfonate (SDBS); ethoxylated nonylphenol with an ethoxy chain of 2-20 units, more specifically 9.5 units (NP95); ethoxylated alcohols, more specifically, Alkonat L70 and L90; polyethylene glycol, polypropylene glycol, or a copolymer composed of both, more specifically pluronic 31R1 and pluronic 10R5; sodium lauryl sulfate; polyvinyl alcohol (PVA), and polyvinyl methyl ether.

6. The formulation according to claim 1, wherein the silicone-based active ingredient is emulsified in the liquid dispersant mixture of the formulation and the fluorosilicone is emulsified inside the microcapsules present in the formulation.

7. A process for preparing microcapsules of silicone and/or their derivatives, wherein the process comprises:
(a) preparing an oily solution of a solvent, a encapsulating material a microcapsule shell, and at least one silicone-based active ingredient and/or its derivatives;
(b) dispersing the solution obtained in (a);
(c) removing the solvent; and
(d) washing the solids.

8. The process according to claim 7, wherein the solvent is selected from the group comprising butanone, ethyl acetate, ethanol, kerosene, Solbrax (Petrobras), chloroform, heptane, tributyl phosphate and cardanol, the shell-forming substance is selected from the group comprising cellulose derivatives, such as methyl cellulose, ethyl cellulose, hydroxymethyl cellulose, carboxymethyl cellulose, hydroxypropyl cellulose, cellulose acetate; polyacetates, such as polyvinyl acetate and polyethyl acetate; polymethacrylates, such as polyalkyl methacrylate, preferably butyl methacrylate, and other branches such as isobutyl, 2-ethylhexyl, 3,5,5-trimethylhexyl, isodecyl, lauryl, not limiting; polycaprolactone; polystyrene; polyacrylamide; the active ingredient is selected from the group comprising fluorosilicone, preferably trifluoropropyl (TFP) methylsiloxane, polyether silicone, or polydimethylsiloxane, or a mixture thereof.

9. The process according to claim 8, wherein the solvent is ethyl acetate (0 to 100% v/v), the microcapsule shell-forming substance is ethyl cellulose (0 to 20% w/v), and the active ingredient is fluorosilicone (0 to 20% w/v).

10. A method for reducing foam in oil, wherein the method comprises applying the formulation as defined in claim 1 to an injection system in an industrial plant during primary processing of the oil.
